(19) United States
(12) Patent Application Publication
(10) Pub. No.: US 2022/0109473 A1
(43) Pub. Date: Apr. 7, 2022

(54) TERMINAL AND RADIO COMMUNICATION METHOD

(71) Applicant: NTT DOCOMO, INC., Tokyo (JP)

(72) Inventors: Ryosuke Osawa, Tokyo (JP); Hiroki Harada, Tokyo (JP); Kazuki Takeda, Tokyo (JP); Yuichi Kakishima, Tokyo (JP)

(73) Assignee: NTT DOCOMO, INC., Tokyo (JP)

(21) Appl. No.: 17/644,723

(22) Filed: Dec. 16, 2021

Related U.S. Application Data
(63) Continuation of application No. 16/322,167, filed on Jan. 31, 2019, now abandoned.

(30) Foreign Application Priority Data
Aug. 3, 2016 (JP) 2016-152973

(51) Int. Cl. H04B 7/0456; H04J 1/00; H04B 7/0413; H04B 7/0404; H04W 72/04; H04W 80/02

(52) U.S. Cl. CPC H04B 7/0456; H04J 1/00; H04W 80/02; H04B 7/0404; H04W 72/042; H04B 7/0413

(57) ABSTRACT

A terminal is disclosed that includes a transmitter that transmits an uplink (UL) signal which is precoded per precoding group that includes a given number of frequency resource units; and a processor that controls precoding of the UL signal. The processor determines a size of the precoding group of the UL signal based on a downlink signal (DL) signal. In other aspects, a radio communication method is also disclosed.

### CROSS-REFERENCE TO RELATED APPLICATIONS

The present application is a continuation application and, thereby, claims benefit under 35 U.S.C. § 120 to U.S. application Ser. No. 16/322,167, filed on Jan. 31, 2019, titled “USER TERMINAL AND RADIO COMMUNICATION METHOD,” which is a U.S. National Stage Application of PCT Application No. PCT/JP2017/028017, filed on Aug. 2, 2017, which claims priority to Japanese Patent Application No. 2016-152973, filed on Aug. 3, 2016. The contents of the priority applications are incorporated by reference in their entirety.

### TECHNICAL FIELD

The present invention relates to a user terminal and a radio communication method in next-generation mobile communication systems.

### BACKGROUND ART

In the UMTS (Universal Mobile Telecommunications System) network, the specifications of long-term evolution (LTE) have been drafted for the purpose of further increasing high speed data rates, providing lower delays and so on (see non-patent literature 1). Also, the specifications of LTE-A (also referred to as “LTE-Advanced,” “LTE Rel. 10 to 13,” and/or the like) have been drafted for further broadbandization and increased speed beyond LTE (also referred to as “LTE Rel. 8 or 9”), and successor systems of LTE (also referred to as, for example, “FRA (Future Radio Access),” “5G (5th generation mobile communication system),” “NR (New RAT (Radio Access Technology) and/or New Radio),” “LTE Rel. 14 and later versions,” and/or the like) are under study.

In the uplink (UL) of existing LTE systems (LTE Rel. 10 or later version), multi-antenna transmission is supported up to four layers (antenna ports). To be more specific, a user terminal precodes a UL signal based on the precoding matrix (PM) indicator (PMI) that is specified by the radio base station, and transmits the resulting signal to the radio base station.

Also, the user terminal multiplexes a demodulation reference signal (DM-RS), to which the same PM as that of the UL signals is applied, to the UL signal. The radio base station performs channel estimation using this DM-RS, thereby demodulating the UL signal without an explicit report of the PM applied to this UL signal.

### CITATION LIST

### Non-Patent Literature

Non-Patent Literature 1: 3GPP TS 36.300 V8.12.0 “Evolved Universal Terrestrial Radio Access (E-UTRA) and Evolved Universal Terrestrial Radio Access Network (E-UTRAN); Overall description; Stage 2 (Release 8),” April, 2010

### SUMMARY OF INVENTION

### Technical Problem

Envisaging future radio communication systems (for example, 5G, NR, etc.), studies are underway to use different access schemes (for example, OFDMA (Orthogonal Frequency Division Multiple Access) as in the DL) from SC-FDMA (Single Carrier-Frequency Division Multiple Access) that is used in the UL of existing LTE systems.

In wideband communication such as OFDMA, the frequency characteristics differ per band that is used. It then follows that, if the same precoding matrix (PM) is applied to the whole frequency band that is allocated for UL signals, there is a possibility the gain of multi-antenna transmission cannot be gained effectively and the receiving characteristics of UL signals will deteriorate.

Therefore, in the UL of future radio communication systems, it is preferable to improve the receiving characteristics of UL signals by making it possible to apply different precoding matrices (PMs) per precoding group (PRG (also referred to as “precoding resource block group,” and/or the like)), which is obtained by dividing the whole of the frequency band that is allocated to UL signals.

The present invention has been made in view of the above, and it is therefore an object of the present invention to provide a user terminal and a radio communication method, whereby the receiving characteristics of UL signals can be improved in multi-antenna transmission in the UL of future radio communication systems.

### Solution to Problem

A user terminal according to one aspect of the present invention has a transmission section that transmits an uplink (UL) signal, which is precoded per precoding group that includes a given number of frequency resource units, and a control section that controls precoding of the UL signal, and the control section controls a size of the precoding group in a frequency direction.

### Advantageous Effects of Invention

According to the present invention, it is possible to improve the receiving characteristics of UL signals in multi-antenna transmission in the UL of future radio communication systems.

### BRIEF DESCRIPTION OF DRAWINGS

FIG. 1 is a diagram to illustrate an example of the relationship between the band used and receiving characteristics;

FIG. 2 is a diagram to illustrate an example of PRG size control according to a first aspect of the present invention;

FIG. 3 is a diagram to illustrate an example of PRG size control according to a second aspect of the present invention;

FIG. 4 is a diagram to illustrate an example of PRG size control according to a third aspect of the present invention;

FIG. 5 is a diagram to illustrate an example of first autonomous control of PRG size according to a fourth aspect of the present invention;

FIG. 6 is a diagram to illustrate an example of the operation of a user terminal according to the fourth aspect;

FIG. 7 is a diagram to illustrate an example of a second autonomous control of the PRG size according to the fourth aspect;

FIG. 8 is a diagram to illustrate an example of PRG size control according to a first variation;

FIG. 9 is a diagram to illustrate an example of PRG size control according to a second variation;

FIG. 10 is a diagram to illustrate an example of PRG size control according to a third variation;

FIG. 11 is a diagram to illustrate an example of PRG size control according to a fourth variation;

FIG. 12 is a diagram to illustrate an example of PRG size control according to a fifth variation;

FIG. 13 is a diagram to illustrate an example of a schematic structure of a radio communication system according to the present embodiment;

FIG. 14 is a diagram to illustrate an example of an overall structure of a radio base station according to present embodiment;

FIG. 15 is a diagram to illustrate an example of a functional structure of a radio base station according to present embodiment;

FIG. 16 is a diagram to illustrate an example of an overall structure of a user terminal according to present embodiment;

FIG. 17 is a diagram to illustrate an example of a functional structure of a user terminal according to present embodiment; and

FIG. 18 is a diagram to illustrate an example hardware structure of a radio base station and a user terminal according to the present embodiment.

### DESCRIPTION OF EMBODIMENTS

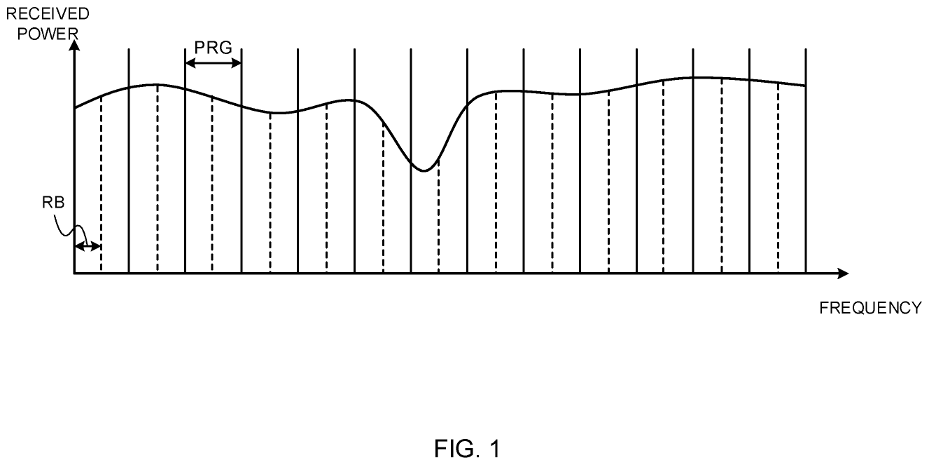

FIG. 1 is a diagram to illustrate an example of the relationship between the band that is used and receiving characteristics. As illustrated in FIG. 1, every frequency demonstrates different frequency characteristics. Consequently, the DL in existing LTE systems (for example, Rel. 10 and/or later versions) is configured so that different precoding matrices (PMs) can be applied on a per PRG basis, where a PRG is comprised of a predetermined number of resource blocks (RBs). As the number of RBs to constitute a PRG (PRG size), a fixed value corresponding to the system bandwidth is used. Note that system bandwidth is also referred to as “cell (carrier, component carrier, etc.) bandwidth” and so on.

For example, in the DL of existing LTE systems, the PRG size is 1 RB when the system bandwidth is smaller than 10 RBs, the PRG size is 2 RBs when the system bandwidth is 11 to 26 RBs, the PRG size is 3 RBs when the system bandwidth is 27 to 63 RBs, and the PRG size is 2 RBs when the system bandwidth is 64 to 110 RBs.

Meanwhile, the UL in existing LTE system does not support precoding per PRG. In the UL of existing LTE systems, SC-FDMA is used, and transmission signals are generated based on DFT (Discrete Fourier Transform)-spread OFDM. This is because, when, in DFT-spread OFDM, precoding is performed on a per PRG basis, the single-carrier characteristics will collapse, and the peak-to-average power ratio (PAPR) might increase.

Meanwhile, for the UL of future radio communication systems (for example, 5G, NR, etc.), studies are underway to apply different access schemes from SC-FDMA (for example, as in the DL, OFDMA). In wideband communication such as OFDMA, the frequency characteristics are different for every band that is used. Consequently, if the same precoding matrix (PM) is applied to the whole frequency band that is allocated for UL signals, multi-antenna transmission gain cannot be achieved effectively and the receiving characteristics of UL signals might deteriorate.

It then follows that the UL of future radio communication systems is expected to support precoding per PRG, which is provided by dividing the whole frequency band that is allocated for UL signals. The problem in this case is how to control the PRG size of UL signals. So, the present inventors have studied a method of controlling the PRG size of UL signals when precoding is executed per PRG in the UL of future radio communication systems, and arrived at the present invention.

Now, embodiments of the present invention will be described below in detail with reference to the accompanying drawings. In the present embodiment, a user terminal transmits UL signals that are precoded on a per precoding group basis, where a precoding group is comprised of a predetermined number of frequency resource units. Furthermore, the user terminal controls the size of these precoding groups in the frequency direction.

Although the following description will assume that a precoding resource block group (PRG) is comprised of a predetermined number of resource blocks (RBs), the units of frequency resources to constitute precoding groups according to the present embodiment are not limited to RBs.

Note that, although, with the present embodiment, a UL data channel (also referred to as “PUSCH (Physical Uplink Shared CHannel),” “UL shared channel,” and so on) will be described as an example of a UL signal that is precoded per PRG, this is by no means limiting, and other UL signals can be used as well. Also, although the present embodiment will describe a DL data channel (also referred to as “PUSCH (Physical Downlink Shared CHannel),” “DL shared channel,” and so on) as an example of a DL signal that is precoded per PRG, this is by no means limiting, and other DL signals can be used as well.

(First Aspect)

According to the first aspect of the present invention, a user terminal sets the size of PRGs (PRG size) of UL signals (for example, PUSCH) in the frequency direction to a fixed size based on the system bandwidth of the user terminal.

In the first aspect, a fixed size (fixed value) corresponding to the system bandwidth may be indicated by the number of RBs. For example, when the system bandwidth is 100 RBs, the fixed size may be 3 RBs. Also, when the system bandwidth is 40 RBs, the fixed size may be 2 RBs. Note that, when the system bandwidth is less than a predetermined number of RBs (for example, 10 RBs), the fixed size may be 1 RB.

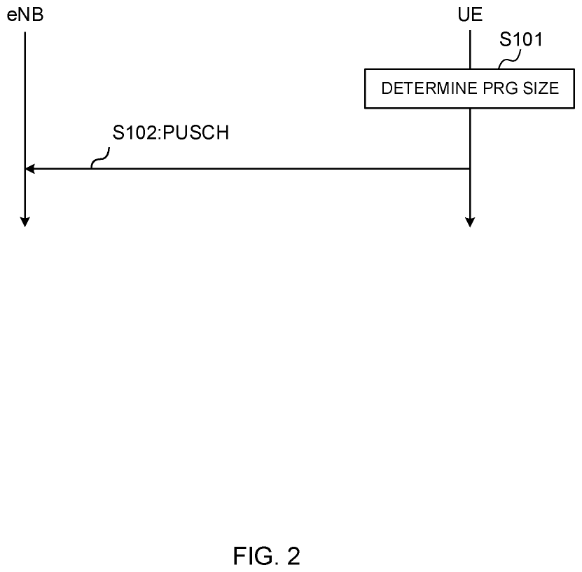

FIG. 2 is a diagram to illustrate an example of PRG size control according to the first aspect. As illustrated in FIG. 2, the user terminal determines the size of PRG to a fixed size based on the system bandwidth of the user terminal (step S101). The user terminal transmits a PUSCH, which is precoded per PRG of the determined PRG size, to the radio base station (step S102).

In FIG. 1, the precoding matrix (PM) of each PRG that is used to precode the PUSCH may be determined autonomously by the user terminal (first PM determination), or the precoding matrix of each PRG may be determined in the radio base station, and PMI information to represent the indicator of the precoding matrix (PMI (Precoding Matrix Indicator)) may be provided to the user terminal (second PM determination).

In the above-noted first determination of PMs, the user terminal may determine the precoding matrix of each PRG that is used to precode the PUSCH, based on DL channel estimation values. These DL channel estimation values can be obtained by channel estimation using DL reference signals (for example, cell-specific reference signals (CRSs), channel state information reference signals (CSI-RSs), and/or other signals).

For example, in the event the time division duplex (TDD) scheme is used, if the same frequency band is used in the UL and the DL, this means that DL channels and UL channels are correlated, so that channel estimation values in the DL can be used in channel estimation in the UL. Consequently, the user terminal may determine the precoding matrix (or the PMI) of each PRG that is used to precode the PUSCH, based on each PRG's channel estimation value in the DL.

Also, in the event the frequency division duplex (FDD) scheme is used, if the direction of arrival, the degree of attenuation and/or others are equal between the UL and the DL, this means that DL channels and UL channels are correlated, so that channel estimation values in the DL can be used in channel estimation in the UL. Consequently, the user terminal may determine the precoding matrix (or PMI) per PRG which is used for precoding the PUSCH based on the channel estimation value per PRG in the DL.

In the first determination of PMs described above, the user terminal multiplexes and transmits a demodulation reference signal (DM-RS), which is precoded using the same precoding matrix as that of the PUSCH, with the PUSCH. The radio base station demodulates the PUSCH using the DM-RS. A DM-RS that is applied the same precoding as that of the PUSCH is multiplexed and transmitted with the PUSCH, so that, even without reporting PMIs from the user terminal to the radio base station on a per PRG basis, the radio base station can demodulate the PUSCH.

Meanwhile, when the second PM is determined as described above, the radio base station determines the precoding matrix of each PRG that is used to precode the PUSCH, based on UL channel estimation values. These UL channel estimation values can be obtained by channel estimation using UL reference signals (for example, sounding reference signals (SRSs)).

Furthermore, in the above determination of the second PM, the radio base station transmits PMI information, which represents each PRG's determined precoding matrix, to the user terminal. This PMI information may be comprised of each PRG's PMI, or may be comprised of the PMI of a reference PRG and information to represent gaps from this PMI. By reporting gaps alone, the overhead can be reduced.

This PMI information may be included in downlink control information (DCI (Downlink Control Information), UL grant, and so on) that allocates the PUSCH, and transmitted by physical layer signaling (for example, PDCCH (Physical Downlink Control CHannel) or EPDCCH (Enhanced Physical Downlink Control CHannel)). Alternatively, the PMI information may be transmitted by higher layer signaling (for example, RRC (Radio Resource Control) signaling), or by higher layer signaling and physical layer signaling.

Also in the above determination of the second PM, too, the user terminal can multiplex and transmit a DM-RS which is precoded using the same precoding matrix as that of the PUSCH, with the PUSCH. By this means, even when the user terminal applies a precoding matrix that does not correspond to the PMI specified by the radio base station, to the PUSCH, the radio base station can still demodulate this PUSCH properly.

According to the first aspect, the size of PRGs is controlled to a fixed size that is determined based on the system bandwidth, so that the user terminal and the radio base station can share PRG size without explicit signaling. Consequently, it is possible to improve the receiving characteristics of UL signals by executing precoding on a per PRG basis, without increasing the overhead accompanying the signaling of PRG size.

(Second Aspect)

According to a second aspect of the present invention, a user terminal determines the PRG size of UL signals (for example, PUSCH) based on the PRG size of DL signals (for example, PDSCH). Now, the second aspect will be described below, primarily focusing on differences from the first aspect.

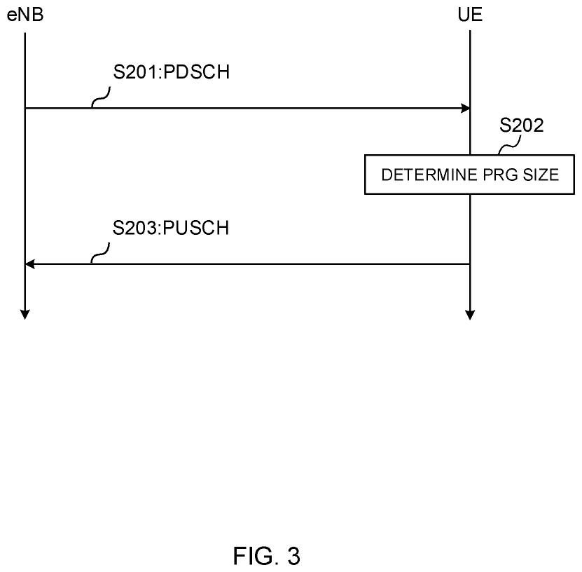

FIG. 3 is a diagram to illustrate an example of PRG size control according to the second aspect. As illustrated in FIG. 3, the user terminal receives a PDSCH (step S201). The PRG size of this PDSCH may be a fixed value determined in advance based on the system band, or may be reported to the user terminal via higher layer signaling (for example, RRC signaling) and/or DCI.

The user terminal determines the PRG size for the PUSCH based on the PRG size for the PDSCH (step S202). For example, the user terminal may set the PRG size of the PUSCH to be the same as the PRG size of the PDSCH. The user terminal transmits the PUSCH, which is precoded per PRG of the determined PRG size, to the radio base station (step S203).

In FIG. 2, the precoding matrix (PM) of each PRG that is used to precode the PUSCH may be determined autonomously by the user terminal (first PM determination), or the precoding matrix of each PRG may be determined in the radio base station, and PMI information to represent the indicator of the precoding matrix (PMI (Precoding Matrix Indicator)) may be provided to the user terminal (second PM determination). Since the details of the first and second PM determinations are the same as in the first aspect, the description thereof will be omitted.

Alternatively, the precoding matrix (PM) of each PRG that is used to precode the PUSCH may be the same as the precoding matrix of each PRG that is used to precode the PDSCH. The PM of each PRG of the PDSCH may be detected at the user terminal using the demodulation reference signal (DM-RS) multiplexed on this PDSCH (non-codebook-based), or may be reported explicitly from the radio base station (codebook-based).

According to the second aspect, the PRG size of the PUSCH is determined based on the PRG size for the PDSCH, so that the user terminal and the radio base station can share PRG size without explicit signaling. Consequently, it is possible to improve the receiving characteristics of UL signals by executing precoding on a per PRG basis, without increasing the overhead accompanying the signaling of PRG size.

(Third Aspect)

According to a third aspect of the present invention, a user terminal receives information that represents the PRG size (PRG size information) determined in the radio base station, and sets the PRG size of the PUSCH to the size indicated by this PRG size information. Note that the second aspect will be described below, primarily focusing on differences from the first and/or second aspects.

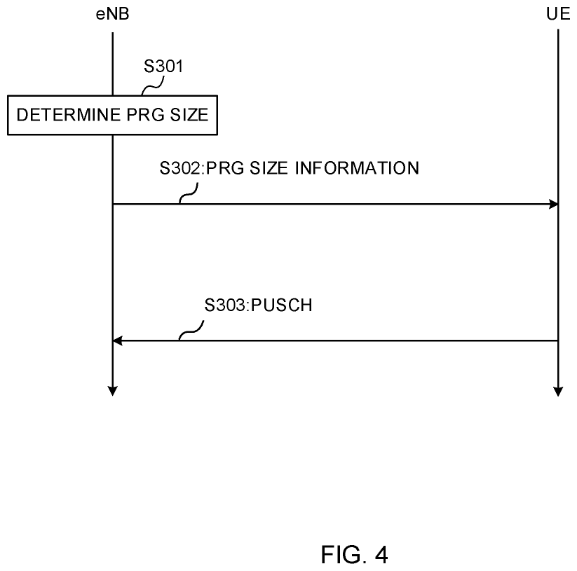

FIG. 4 is a diagram to illustrate an example of how the size of PRGs is determined, according to the third aspect. As illustrated in FIG. 4, the radio base station determines the PRG size for the PUSCH based on UL reference signals (for example, SRS) (step S301). To be more specific, the radio base station determines the PRG size for the PUSCH based on UL channel estimation values obtained by channel estimation using UL reference signals.

The radio base station transmits PRG size information for the PUSCH to the user terminal (step S302). This PRG size information is transmitted to the user terminal via higher layer signaling (for example, RRC (Radio Resource Control) signaling) and/or DCI.

The user terminal determines the PRG size of the PUSCH to be the size indicated by the PRG size information from the radio base station, and transmits the PUSCH that is precoded per PRG of the determined PRG size, to the radio base station (step S303).

In FIG. 4, the precoding matrix of each PRG that is used to precode the PUSCH may be determined autonomously by the user terminal (first PM determination), or the precoding matrix of each PRG may be determined in the radio base station, and PMI information to represent the indicator of the precoding matrix (PMI) may be sent to the user terminal (second PM determination). Since the details of the first and second PM determinations are the same as in the first aspect, the description thereof will be omitted.

In the third aspect, the PRG size of the PUSCH is determined by the radio base station and reported to the user terminal. Consequently, it is possible to improve the receiving characteristics of UL signals by executing precoding on a per PRG basis, without increasing the processing load on the user terminal accompanying the signaling of PRG size.

(Fourth Aspect)

According to a fourth aspect of the present invention, a user terminal determines the PRG size of the PUSCH autonomously, and transmits information about the precoding of the PUSCH (precoding information). Here, the precoding information may be at least one of information that represents the PRG size of the PUSCH, and information to indicate that the PUSCH is precoded on a per PRG basis. In the fourth aspect, the user terminal may determine the PRG size of the PUSCH autonomously based on a command from the radio base station (first autonomous control), or determine the PRG size of the PUSCH autonomously without commands from the radio base station (second autonomous control).

<First Autonomous Control>

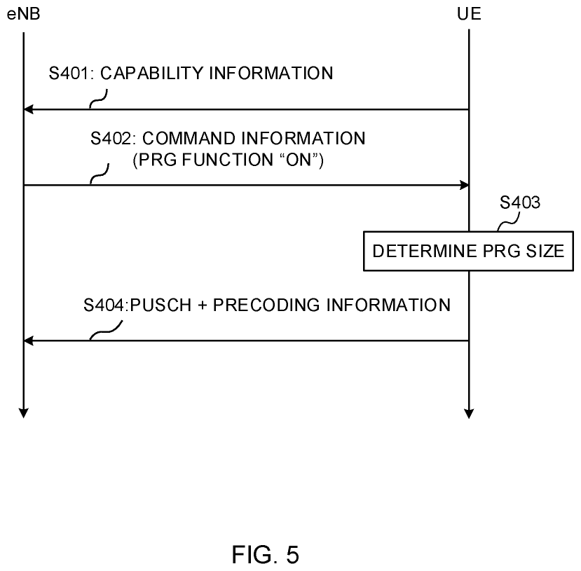

FIG. 5 is a diagram to illustrate an example of first autonomous control of PRG size according to the fourth aspect of the present invention. As illustrated in FIG. 5, the user terminal reports, to the radio base station, capability information that indicates whether or not to support precoding of the PUSCH per PRG, in advance (step S401). For example, the user terminal may transmit this capability information to the radio base station via higher layer signaling.

The radio base station determines whether or not to precode the PUSCH on a per PRG basis, based on the capability information from the user terminal, and transmits command information to represent the determined result (that is, whether to turn on or turn off the precoding function per PRG), to the user terminal (step S402). This command information may be sent to the user terminal via higher layer signaling and/or DCI.

When command information to command that precoding be executed per PRG is received from the radio base station, the user terminal determines the size of PRGs autonomously (step S403). For example, the user terminal may determine the size of PRGs based on at least one of the estimation values of a DL channel that is correlated with a UL channel, the system bandwidth (the number of RBs), the bandwidth (the number of RBs) allocated to the PUSCH addressed to this user terminal, and the user terminal's capability information (for example, when the number of PRGs which the user terminal can support is limited).

The user terminal transmits the PUSCH that is precoded per PRG of the determined PRG size, and precoding information for this PUSCH, to the radio base station (step S404). This precoding information may indicate the PRG size of the PUSCH, or indicate that the PUSCH is precoded on a per PRG basis, without indicating the PRG size, or indicate both.

When the precoding information does not indicate the PRG size but indicates that the PUSCH is precoded on a per PRG basis, the radio base station estimates the PRG size applied to the PUSCH on a blind basis. For example, the radio base station may estimate the PRG size based on at least one of UL channel estimation values, the system bandwidth (the number of RBs), the bandwidth (the number of RBs) allocated to the PUSCH addressed to this user terminal, and the user terminal's capability information (for example, when the number of PRGs which the user terminal can support is limited).

Furthermore, in FIG. 5, the precoding matrix of each PRG that is used to precode the PUSCH may be determined autonomously by the user terminal (first PM determination), or the precoding matrix of each PRG may be determined in the radio base station, and PMI information to represent the indicator of the precoding matrix (PMI) may be sent to the user terminal (second PM determination). Since the details of the first and second PM determinations are the same as in the first aspect, the description thereof will be omitted.

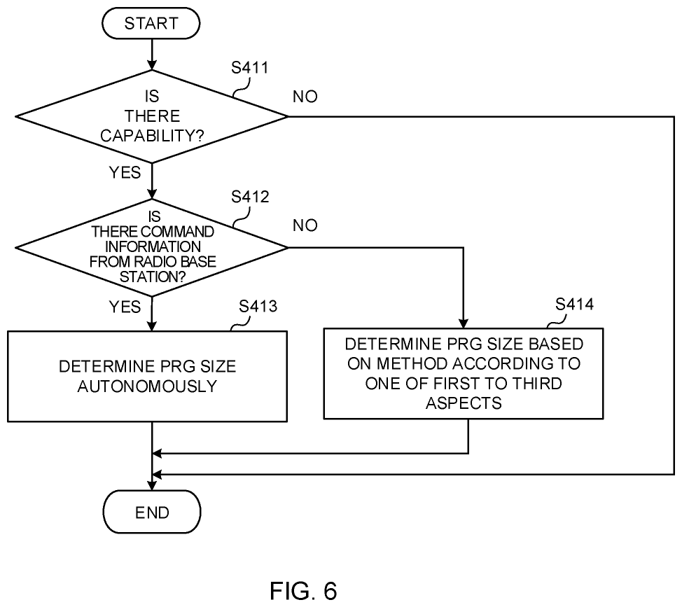

FIG. 6 is a diagram to illustrate an example of the operation of a user terminal according to the fourth aspect. As illustrated in FIG. 6, the user terminal determines whether precoding of the PUSCH per PRG is supported (step S411). When precoding of the PUSCH per PRG is supported (step S411: Yes), the user terminal judges whether command information to command that precoding be executed per PRG is received from the radio base station (step S412). If this command information is received, the user terminal autonomously determines the PRG size of the PUSCH as has been described in step S403 of FIG. 5 (step S413).

Meanwhile, when the user terminal does not support precoding of the PUSCH per PRG (step S411: No), this operation ends. If the user terminal does not receive command information to command that precoding be executed per PRG from the radio base station even though the user terminal supports precoding per PRG (step S412: No), the user terminal determines the size of PRGs using the method described in one of the first to third aspects (step S414).

<Second Autonomous Control>

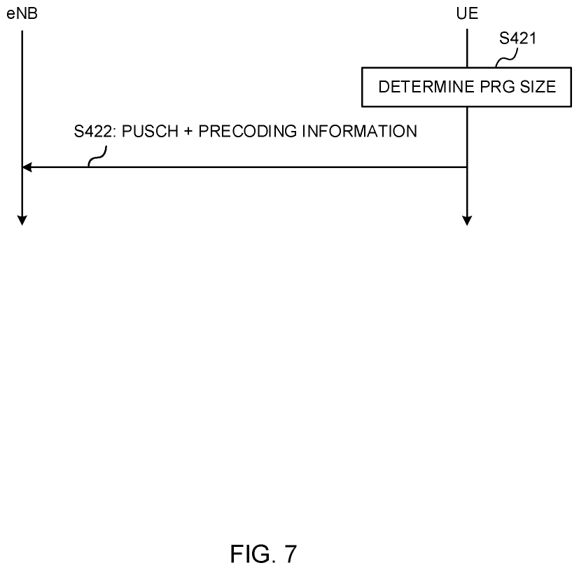

FIG. 7 is a diagram to illustrate an example of second autonomous control of PRG size according to the fourth aspect. As illustrated in FIG. 7, the user terminal autonomously determines the size of PRGs without a command for precoding per PRG from the radio base station (step S421). Note that the details of steps S421 and S422 of FIG. 7 are the same as steps S403 and S404 of FIG. 5, and therefore the description thereof will be omitted here.

Furthermore, in FIG. 7, the precoding matrix of each PRG that is used to precode the PUSCH may be determined autonomously by the user terminal (first PM determination), or the precoding matrix of each PRG may be determined in the radio base station, and PMI information to represent the indicator of the precoding matrix (PMI) may be sent to the user terminal (second PM determination). Since the details of the first and second PM determinations are the same as in the first aspect, the description thereof will be omitted.

In the fourth aspect described above, the PRG size of the PUSCH is determined autonomously by the user terminal. Consequently, it is possible to improve the receiving characteristics of UL signals by executing precoding on a per PRG basis, without increasing the overhead accompanying the signaling of PRG size.

### Alternative Examples

Variations of the PRG size control according to the first to fourth aspects of the present invention described above will be explained. The first to seventh variations explained below can be applied to at least one of the first to fourth aspects described above. It is also possible to combine at least one of the first to seventh variations explained below.

<First Variation>

In the first variation, a user terminal may determine whether or not to determine the PRG size for the PUSCH based on the PRG size for the PDSCH, depending on whether or not the PDSCH is received within the nearest predetermined period. That is, the first variation relates to a combination of the PRG size according to the above second aspect and one of the first to fourth aspects.

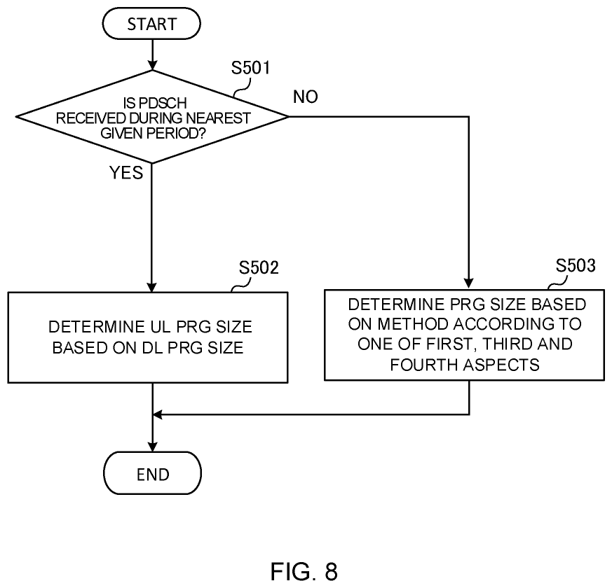

FIG. 8 is a diagram to illustrate an example of PRG size control according to the first variation. As illustrated in FIG. 8, a user terminal determines whether or not the PDSCH is received within the nearest predetermined period (for example, a predetermined number of subframes) (step S501).

When the PDSCH is received within the nearest predetermined period, the user terminal determines the PRG size for the PUSCH based on the PRG size for the PDSCH, as described in the second aspect (step S502). Meanwhile, if the PDSCH is not received within the nearest predetermined period, the user terminal may determine the PRB size based on the method of one of the first, third and fourth aspects (step S503).

According to the first variation, whether or not to determine the PRG size for the PUSCH based on the PRG size for the PDSCH is determined depending on whether or not the PDSCH is received during the nearest predetermined period.

Consequently, it is possible to prevent the PRG size of the PUSCH from being inappropriately determined based on the PRG size of the old PDSCH when the PDSCH is not received in the nearest predetermined period.

<Second Variation>

Although the first to fourth aspects have assumed cases where the PRG size of the PUSCH is constant between PRGs, according to the second variation, the PRG size of the PUSCH does not have to be constant between PRGs.

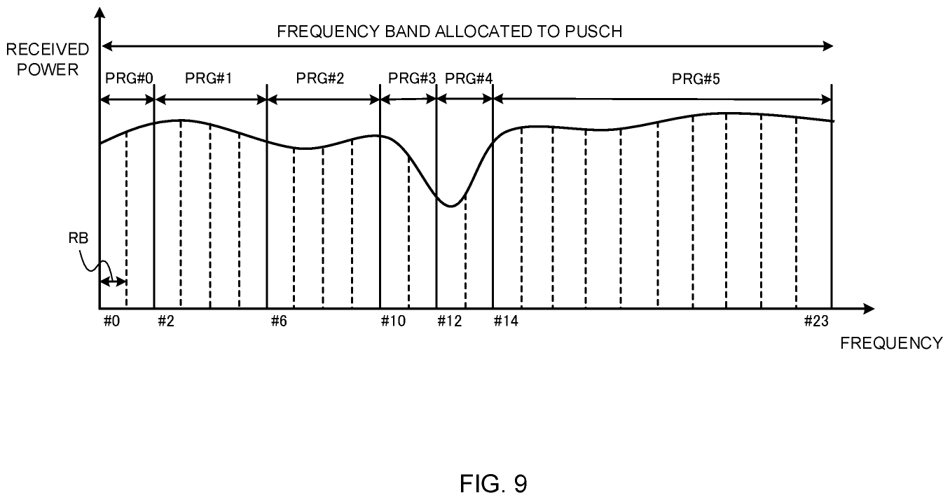

FIG. 9 is a diagram to illustrate an example of PRG size control according to the second variation. As illustrated in FIG. 9, a plurality of PRGs having different PRG sizes may be provided within the frequency band allocated to the PUSCH. For example, each PRG may be comprised of one or more RBs, where the correlation value of frequency response (received power) is equal to or less than a predetermined value.

For example, in FIG. 9, PRGs #0 to #5 are each comprised of one or more RBs whose correlation value of the frequency response (received power) is equal to or less than a predetermined value. For example, in PRG #5 comprised of 10 RBs (RB), the correlation value of received power is equal to or less than a predetermined value, so that the PRG size is larger than the other PRGs #0 to #4.

In FIG. 9, information that represents the PRG size (PRG size information) of PRGs #0 to #5 may be transmitted from the radio base station to the user terminal by higher layer signaling and/or DCI, or may be transmitted from the user terminal to the radio base station.

Here, the PRG size information may represent each PRG's PRG size itself. For example, in FIG. 9, the PRG size information may represent that the PRG size of PRGs #0, #3 and #4 is 2 RBs, the PRG size of PRGs #1 and #2 is 4 RBs, and the PRG size of PRG #5 is 10 RBs. Furthermore, in FIG. 9, the reference PRG size (for example, 2 RBs) may be configured via higher layer signaling, and PRG sizes that are different from the reference PRG size (for example, 4 RBs of PRGs #1 and 2, 10 RBs of PRG #5, etc.) may be specified by DCI.

Alternatively, the PRG size information may be information from which the PRG size of each PRG can be derived (for example, the position where each PRG is divided or the index of the starting RB (RB) of each PRB), rather than each PRG's PRG size itself. For example, as illustrated in FIG. 9, when RB #0 to #23 are allocated to PUSCH, the PRG size information may represent that the starting RB of PRG #0 is RB #0, the starting RB of PRG #1 is RB #2, the starting RB of PRG #2 is RB #6, the starting RB of PRG #3 is RB #10, the starting RB of PRG #4 is RB #12, and the starting RB of PRG #5 is #14.

As described above, according to the second variation, the PRG size of each PRG within the frequency band allocated to the PUSCH is variable, so that it is possible to prevent consecutive RBs whose correlation value is equal to or less than a predetermined value from belonging to a plurality of different PRGs, and reduce the processing load of precoding in the user terminal.

<Third Variation>

With the third variation, how to handle RBs that are left over when a fixed PRG size is used within a frequency band that is allocated to the PUSCH.

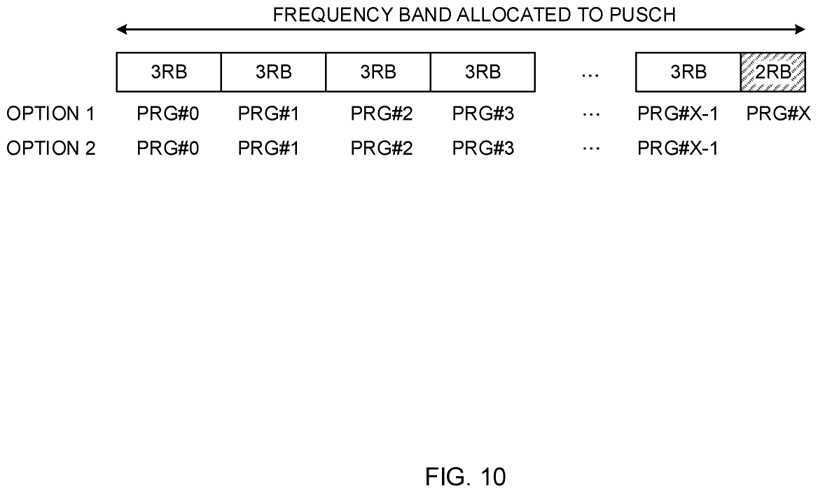

FIG. 10 is a diagram to illustrate an example of PRG size control according to the third variation. In FIG. 10, N RBs are allocated to the PUSCH, the PRG size is 3 RBs, and X is the quotient obtained by dividing N by 3. As illustrated in FIG. 10, if N RBs allocated to the PUSCH is not a multiple of 3, there are remaining RBs (2 RBs in FIG. 10).

In the case illustrated in FIG. 10, X PRGs (PRGs #0 to #X−1) may be comprised of 3 RBs that equal the PRB size, and the remaining 2 RBs may be made one PRB (PRB #X in FIG. 10) (option 1). Alternatively, the remaining 2 RBs may be precoded per RB, instead of being made a PRG (option 2).

According to the third variation, even if a fixed PRG size is used within a frequency band allocated to the PUSCH and some RBs are left over, the user terminal can appropriately perform precoding.

<Fourth Variation>

As described above, each PRG that is used to precode the PUSCH is comprised of a predetermined number of frequency resource units (for example, RBs). In the fourth variation, each PRG may be comprised of a predetermined number of time resource units (for example, subframes, radio frames, transmission time intervals (TTIs), etc.). That is, in the fourth variation, grouping in the time direction may be performed when the PUSCH is precoded.

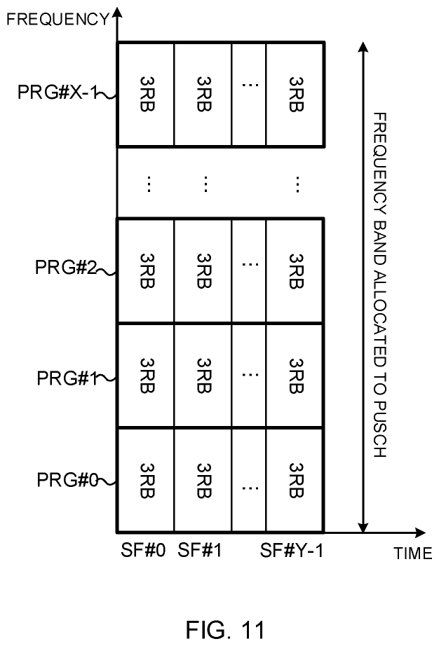

FIG. 11 is a diagram to illustrate an example of PRG size control according to the fourth variation. In FIG. 11, N RBs are allocated to the PUSCH, the PRG size is 3 RBs, and X is the quotient obtained by dividing N by 3. Note that, although FIG. 11 illustrates a case where a fixed PRG size (3 RBs) is used within a frequency band that is allocated to the PUSCH, as explained in the second variation, the size of PRGs in the frequency direction does not have to be constant.

For example, in FIG. 11, Y (Y>0) subframes (SFs) are grouped. As illustrated in FIG. 11, PRBs #0 to #X−1 are comprised of 3 RBs in the frequency direction and Y subframes in the time direction, respectively. As illustrated in FIG. 11, when each PRB is grouped not only in the frequency direction but also in the time direction, it is possible to reduce the frequency information regarding the size of PRGs is reported between the radio base station and the user terminal, and to reduce the overhead.

Note that the grouping in the time direction may be applied when the channel variations between among multiple time resource units (for example, subframes, radio frames, TTIs, and so on) are moderate (for example, the correlation value between channel estimation values in DL and/or UL subframes is equal to or less than a predetermined value).

According to the fourth variation, when the PUSCH is precoded, grouping is performed in the time direction, so that it is possible to reduce the frequency of reporting PRG size, and to reduce the overhead.

<Fifth Variation>

With the fifth variation, a case will be described in which different numerologies (for example, different subcarrier spacings, symbol durations and so on) are co-present. For future radio communication systems, it is assumed that different numerologies will be used in the DL and the UL. Furthermore, future radio communication systems are expected to use several different numerologies in the same UL cell (carrier, CC, etc.).

Thus, in the event multiple different numerologies are co-present, if the size of PRGs in the frequency direction is determined based on the number of frequency resource units (for example, RBs), there is a possibility that the size of PRGs in the frequency direction cannot be controlled adequately. Therefore, in the fifth variation, the size of PRGs in the frequency direction may be specified based on the frequency bandwidth (for example, ** kHz, ** MHz, etc.).

Also, when multiple different numerologies are co-present, as explained in the fourth variation, if the size of PRGs in the time direction is defined based on the number of time resource units (for example subframes, TTIs, radio frames and so on), there is a possibility that the size of PRGs in the time direction cannot be controlled adequately. Therefore, in the fifth variation, the size of PRGs in the time direction may be specified based on time (for example, ** ms).

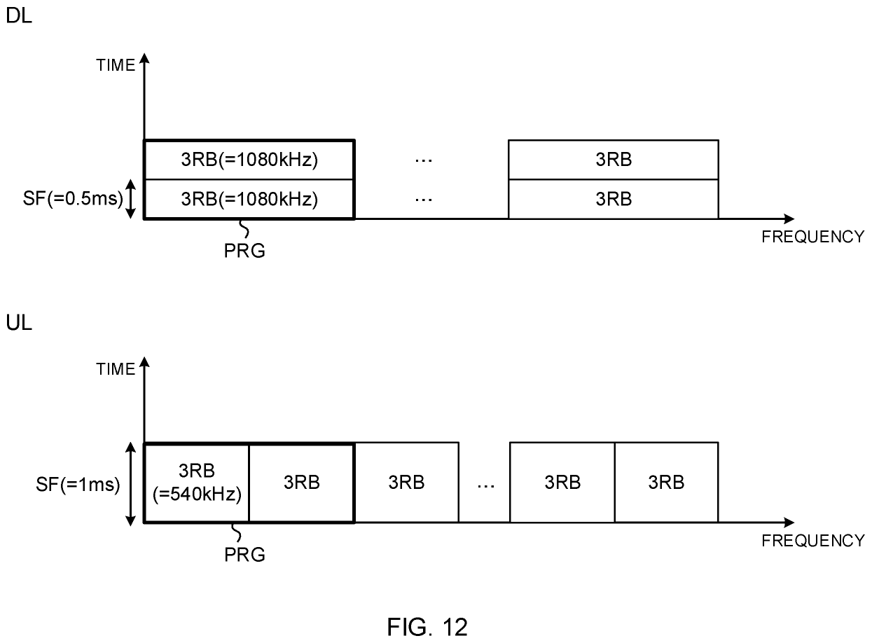

FIG. 12 is a diagram to illustrate an example of PRG size control according to the fifth variation. For example, a case will be described below, with reference to FIG. 12, where, in the UL, the same subcarrier spacing (15 kHz) is used as in existing LTE systems, and in the DL, a different subcarrier spacing (for example, 30 kHz) is used than existing LTE systems. In addition, in FIG. 12, the number of subcarriers per RB (for example, 12) is the same in both the DL and the UL, and is the number of symbols per subframe (for example, 14).

Note that, as explained in the fourth variation, although FIG. 12 assumes a case where PRGs are grouped not only in the frequency direction, but also in the time direction, grouping in the time direction does not necessarily have to be performed.

For example, in FIG. 12, in the UL, the frequency bandwidth of PRGs comprised of 3 RBs is 540 kHz (=15 kHz×12 subcarriers×3 RBs), while, in the DL, the frequency bandwidth of PRGs comprised of 3 RBs is 1080 kHz (=30 kHz×12 subcarriers×3 RBs).

Also, given that the subcarrier spacing and the symbol duration are reciprocal, if the subcarrier spacing is 2, the symbol duration becomes 1/2. In FIG. 12, the number of symbols per subframe is the same in both of the DL and the UL, so that the duration of DL subframe is 0.5 ms, which is 1/2 of the duration of UL subframes (1 ms).

In the case illustrated in FIG. 12, a user terminal may calculate the frequency bandwidth per PRG based on the size of PRGs (here 3 RBs) in the frequency direction in the DL, and, based on this frequency bandwidth, determine the size of PRGs in the frequency direction in the UL. As described above, in FIG. 12, 3 RBs in the DL are 1080 kHz, while 3 RBs in the UL are 540 kHz, which is 1/2 of the DL. Consequently, the user terminal determines the size of PRGs (the number of RBs per PRG) in the frequency direction in the UL to be 6 RBs, which is twice the DL, so that the frequency bandwidth per PRG is equal between the DL and the UL.

Furthermore, the user terminal may calculate the time duration of each PRG based on the size of PRGs in the time direction in the DL (here, two subframes (SFs)), and, based on this time duration, determine the size of PRGs in the time direction in the UL. In FIG. 12, two SFs in the DL are 1 ms (=0.5 ms×2), and two SFs in the UL are 2 ms (=1 ms×2), which is twice as large as the DL. Consequently, the user terminal determines the size of PRGs (the number of SFs per PRG) in the time direction of the UL to be 1 SF, which is 1/2 of the DL, so that the time duration per PRG is equal between the DL and the UL.

Thus, in the fifth variation, the user terminal may calculate the frequency bandwidth and/or time duration per PRG based on the size of PRGs in the frequency direction and/or the time direction in the DL, and, based on this frequency bandwidth and/or time duration, determine the size of PRGs in the frequency direction and/or the time direction in the UL (option 1).

Alternatively, in the fifth variation, the size of PRGs in the frequency direction and/or in the time direction in the UL may be specified by the actual frequency bandwidth (for example, ** kHz, ** MHz, etc.) and/or time duration (for example, ** ms). For example, in FIG. 12, the size of PRGs in the UL may be specified as 1080 kHz and 1 ms. In this case, the fixed value corresponding to the system bandwidth according to the first aspect may also be frequency bandwidth and/or time duration.

As described above, in the fifth variation, the size of PRGs is specified based on frequency bandwidth (for example, ** kHz, ** MHz, etc.) and/or time duration (for example, ** ms), rather than based on the number of resource units in the frequency direction and/or the time direction (for example, the number of RBs and/or the number of SFs). Consequently even when multiple different numerologies are co-present between the DL and the UL (or within the same UL carrier), the size of PRGs in the UL can be controlled adequately.

<Sixth Variation>

In the sixth variation, precoding of UL reference signals will be explained. As described above, in the event precoding is applied to the PUSCH on a per PRG basis, the user terminal can multiplex and transmit a demodulation reference signal (DM-RS), which is precoded using the same precoding matrix as each PRG's PMI, with the PUSCH in each PRG.

Meanwhile, in the sixth variation, precoding does not be applied per PRG to other UL reference signals (for example, sounding reference signals (SRSs)) that are not used to demodulate the PUSCH. The SRS is a UL reference signal for determining overall UL channel evaluation in the system bandwidth. Consequently, if precoding is applied to the SRS on a per PRG basis, there is a possibility that the gain obtained by precoding will differ from PRG to PRG, which might result in a failure to perform appropriate channel estimation.

(Radio Communication System)

Now, the structure of a radio communication system according to the present embodiment will be described below. In this radio communication system, each radio communication method according to the above-described aspects of the present invention is employed. Note that the radio communication method according to each above-described aspect may be used alone or may be used in combination. Note that the radio communication methods according to each above-described variation may be applied alone or may be used in combination.

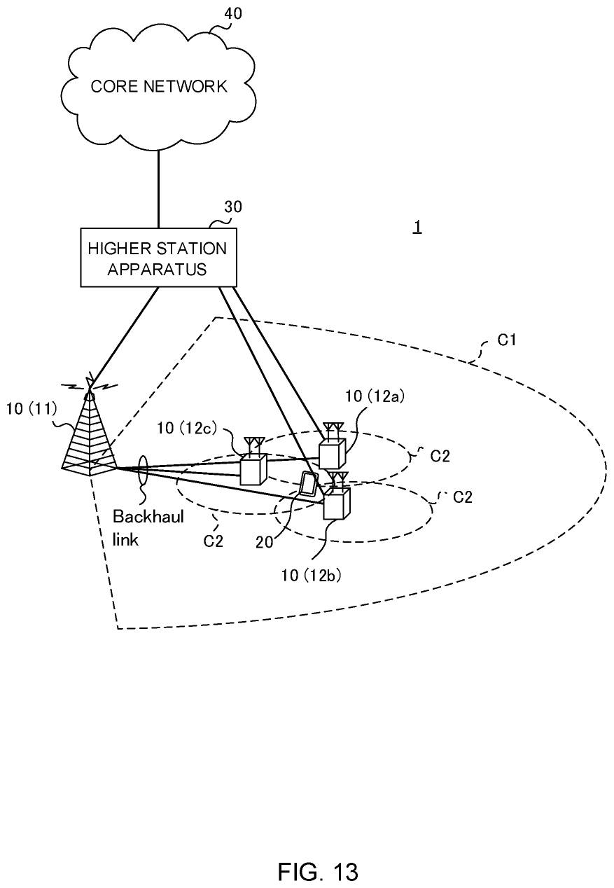

FIG. 13 is a diagram to illustrate an example of a schematic structure of a radio communication system according to the present embodiment. A radio communication system 1 can adopt carrier aggregation (CA) and/or dual connectivity (DC) to group a plurality of fundamental frequency blocks (component carriers) into one, where the LTE system bandwidth (for example, 20 MHz) constitutes one unit. Note that the radio communication system 1 may be referred to as “SUPER 3G,” “LTE-A (LTE-Advanced),” “IMT-Advanced,” “4G,” “5G,” “FRA,” “NR,” and/or the like.

The radio communication system 1 illustrated in FIG. 13 includes a radio base station 11 that forms a macro cell C1, and radio base stations 12a to 12c that form small cells C2, which are placed within the macro cell C1 and which are narrower than the macro cell C1. Also, user terminals 20 are placed in the macro cell C1 and in each small cell C2. A configuration in which different numerologies are applied between cells may be adopted.

Here, “numerology” refers to communication parameters in the frequency direction and/or the time direction (for example, at least one of subcarrier spacing, bandwidth, symbol duration, CP duration, TTI duration, the number of symbols per TTI, radio frame configuration, filtering process, windowing process, and/or others).

The user terminals 20 can connect with both the radio base station 11 and the radio base stations 12. The user terminals 20 may use the macro cell C1 and the small cells C2, which use different frequencies, at the same time, by means of CA or DC. Also, the user terminals 20 can adopt CA or DC by using a plurality of cells (CCs) (for example, two or more CCs). Furthermore, the user terminals can use license band CCs and unlicensed band CCs as a plurality of cells.

Furthermore, the user terminals 20 can communicate by using time division duplexing (TDD) or frequency division duplexing (FDD) in each cell. A TDD cell and an FDD cell may be referred to as, for example, a “TDD carrier (frame structure type 2)” and an “FDD carrier (frame structure type 1),” respectively.

Also, in each cell (carrier), either subframes that have a relatively long time duration (for example, 1 ms) (also referred to as “TTIs,” “normal TTIs,” “long TTIs,” “normal subframes,” “long subframes,” and/or the like) or subframes that have a relatively short time duration (also referred to as “short TTIs,” “short subframes,” and/or the like) may be applied, or both long subframes and short subframe may be used. Furthermore, in each cell, subframes of two or more time durations may be applied.

In a frequency band that is relatively low (for example, 2 GHz, 3.5 GHz, 5 GHz, 6 GHz and so on), the user terminals 20 and the radio base station 11 can communicate using a relatively narrow subcarrier spacing. Meanwhile, in a frequency band that is relatively high (for example, 28 GHz, 30 to 70 GHz and so on), the user terminals 20 and the radio base stations 12 may use a relatively wide subcarrier spacing or use the same carrier as that used in the radio base station 11. Note that the structure of the frequency band for use in each radio base station is by no means limited to these.

A structure may be employed here in which wire connection (for example, means in compliance with the CPRI (Common Public Radio Interface) such as optical fiber, the X2 interface and so on) or wireless connection is established between the radio base station 11 and the radio base station 12 (or between two radio base stations 12).

The radio base station 11 and the radio base stations 12 are each connected with higher station apparatus 30, and are connected with a core network 40 via the higher station apparatus 30. Note that the higher station apparatus 30 may be, for example, access gateway apparatus, a radio network controller (RNC), a mobility management entity (MME) and so on, but is by no means limited to these. Also, each radio base station 12 may be connected with the higher station apparatus 30 via the radio base station 11.

Note that the radio base station 11 is a radio base station having a relatively wide coverage, and may be referred to as a “macro base station,” a “central node,” an “eNB (eNodeB),” a “transmitting/receiving point” and so on. Also, the radio base stations 12 are radio base stations having local coverages, and may be referred to as “small base stations,” “micro base stations,” “pico base stations,” “femto base stations,” “HeNBs (Home eNodeBs),” “RRHs (Remote Radio Heads),” “transmitting/receiving points” and so on. Hereinafter the radio base stations 11 and 12 will be collectively referred to as “radio base stations 10,” unless specified otherwise.

The user terminals 20 are terminals to support various communication schemes such as LTE, LTE-A and so on, and may be either mobile communication terminals or stationary communication terminals. Furthermore, the user terminals 20 can perform inter-terminal (D2D) communication with other user terminals 20.

In the radio communication system 1, as radio access schemes, OFDMA (Orthogonal Frequency Division Multiple Access) can be applied to the downlink (DL), and SC-FDMA (Single-Carrier Frequency Division Multiple Access) can be applied to the uplink (UL). OFDMA is a multi-carrier communication scheme to perform communication by dividing a frequency band into a plurality of narrow frequency bands (subcarriers) and mapping data to each subcarrier. SC-FDMA is a single-carrier communication scheme to mitigate interference between terminals by dividing the system bandwidth into bands formed with one or more continuous RBs, per terminal, and allowing a plurality of terminals to use mutually different bands. Note that the uplink and downlink radio access schemes are not limited to the combinations of these, and OFDMA may be used in the UL.

In the radio communication system 1, a DL shared channel (PDSCH (Physical Downlink Shared CHannel), which is also referred to as, for example, a “DL data channel”), which is used by each user terminal 20 on a shared basis, a broadcast channel (PBCH (Physical Broadcast CHannel)), L1/L2 control channels and so on, are used as DL channels. User data, higher layer control information, SIBs (System Information Blocks) and so on are communicated in the PDSCH. Also, the MIB (Master Information Block) is communicated in the PBCH.

The L1/L2 control channels include DL control channels (a PDCCH (Physical Downlink Control CHannel), an EPDCCH (Enhanced Physical Downlink Control CHannel) and so on), a PCFICH (Physical Control Format Indicator CHannel), a PHICH (Physical Hybrid-ARQ Indicator CHannel) and so on. Downlink control information (DCI), including PDSCH and PUSCH scheduling information, is communicated by the PDCCH. The number of OFDM symbols to use for the PDCCH is communicated by the PCFICH. The EPDCCH is frequency-division-multiplexed with the PDSCH and used to communicate DCI and so on, like the PDCCH. PUSCH retransmission control information (A/Ns, HARQ-ACKs, etc.) can be communicated in at least one of the PHICH, the PDCCH and the EPDCCH.

In the radio communication system 1, a UL shared channel (PUSCH (Physical Uplink Shared CHannel), which is also referred to as “UL data channel” and so on), which is used by each user terminal 20 on a shared basis, a UL control channel (PUCCH (Physical Uplink Control CHannel)), a random access channel (PRACH (Physical Random Access CHannel)) and so on are used as UL channels. User data, higher layer control information and so on are communicated by the PUSCH. Uplink control information (UCI), including at least one of PDSCH retransmission control information (A/N, HARQ-ACK, etc.), channel state information (CSI) and so on, is communicated in the PUSCH or the PUCCH. Random access preambles for establishing connections with cells can be communicated by means of the PRACH.

(Radio Base Station)

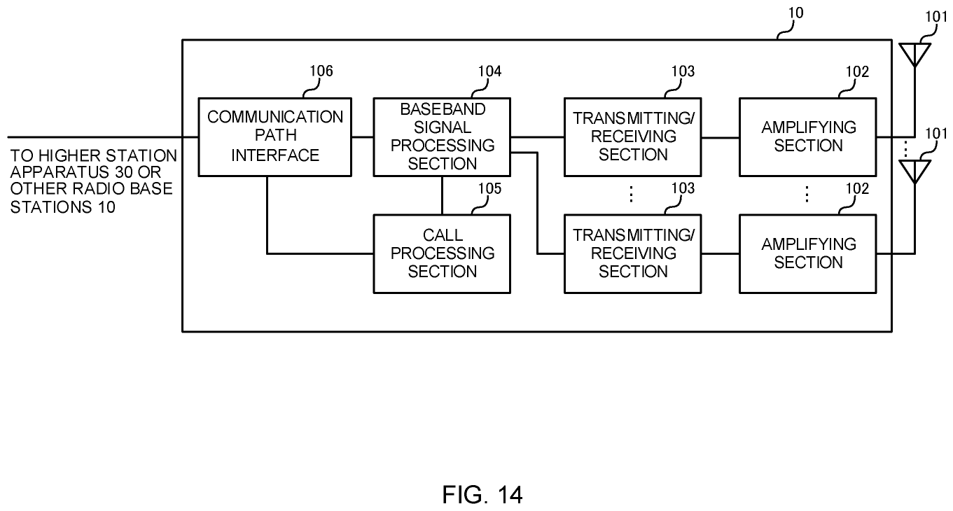

FIG. 14 is a diagram to illustrate an example of an overall structure of a radio base station according to the present embodiment. A radio base station 10 has a plurality of transmitting/receiving antennas 101, amplifying sections 102, transmitting/receiving sections 103, a baseband signal processing section 104, a call processing section 105 and a communication path interface 106. Note that one or more transmitting/receiving antennas 101, amplifying sections 102 and transmitting/receiving sections 103 may be provided.

User data to be transmitted from the radio base station 10 to a user terminal 20 on the downlink is input from the higher station apparatus 30 to the baseband signal processing section 104, via the communication path interface 106.

In the baseband signal processing section 104, the user data is subjected to transmission processes, including a PDCP (Packet Data Convergence Protocol) layer process, division and coupling of the user data, RLC (Radio Link Control) layer transmission processes such as RLC retransmission control, MAC (Medium Access Control) retransmission control (for example, an HARQ (Hybrid Automatic Repeat reQuest) process), scheduling, transport format selection, channel coding, an inverse fast Fourier transform (IFFT) process and a precoding process, and the result is forwarded to each transmitting/receiving section 103. Furthermore, DL control signals are also subjected to transmission processes such as channel coding and an inverse fast Fourier transform, and forwarded to each transmitting/receiving section 103.

Baseband signals that are precoded and output from the baseband signal processing section 104 on a per antenna basis are converted into a radio frequency band in the transmitting/receiving sections 103, and then transmitted. The radio frequency signals having been subjected to frequency conversion in the transmitting/receiving sections 103 are amplified in the amplifying sections 102, and transmitted from the transmitting/receiving antennas 101 as DL signals.

The transmitting/receiving sections 103 can be constituted by transmitters/receivers, transmitting/receiving circuits or transmitting/receiving apparatus that can be described based on general understanding of the technical field to which the present invention pertains. Note that a transmitting/receiving section 103 may be structured as a transmitting/receiving section in one entity, or may be constituted by a transmitting section and a receiving section.

Meanwhile, as for UL signals, radio frequency signals that are received in the transmitting/receiving antennas 101 are each amplified in the amplifying sections 102. The transmitting/receiving sections 103 receive the UL signals amplified in the amplifying sections 102. The received signals are converted into the baseband signal through frequency conversion in the transmitting/receiving sections 103 and output to the baseband signal processing section 104.

In the baseband signal processing section 104, UL data that is included in the UL signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing such as setting up and releasing communication channels, manages the state of the radio base station 10 and manages the radio resources.

The communication path interface section 106 transmits and receives signals to and from the higher station apparatus 30 via a predetermined interface. Also, the communication path interface 106 may transmit and/or receive signals (backhaul signaling) with neighboring radio base stations 10 via an inter-base station interface (for example, optical fiber, which is in compliance with the CPRI (Common Public Radio Interface), the X2 interface, etc.).

Furthermore, the transmitting/receiving sections 103 transmit DL signals, which are precoded on a per precoding group basis. The transmitting/receiving sections 103 receive UL signals, which are precoded on a per precoding group basis. Here, a precoding group is comprised of a predetermined number of frequency resource units (for example, RBs) and will be hereinafter referred to as a “PRG.” Furthermore, a PRG may be comprised of a predetermined number of time resource units (for example, subframes) (fourth variation).

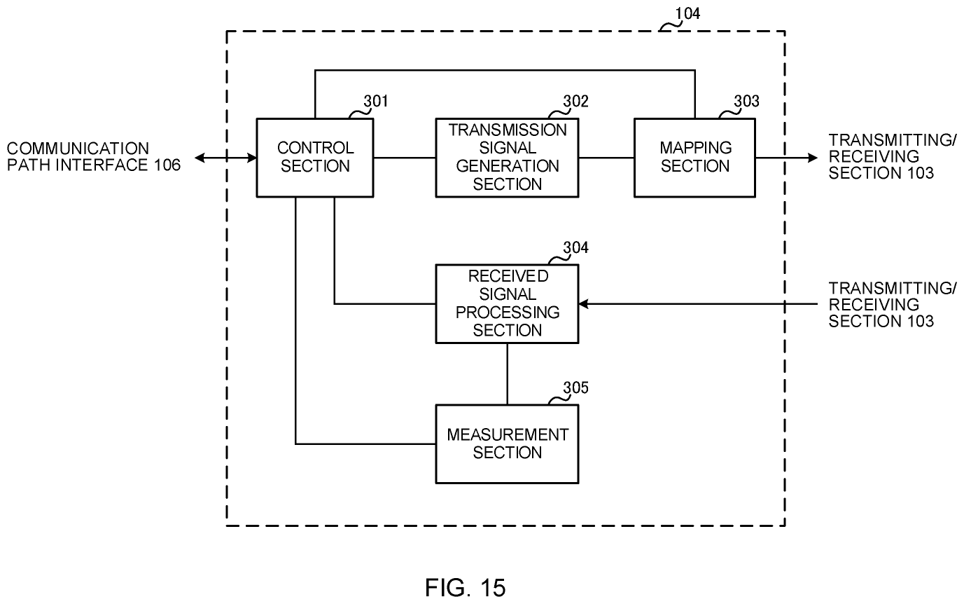

FIG. 15 is a diagram to illustrate an example of a functional structure of a radio base station according to the present embodiment. Note that, although FIG. 15 primarily illustrates functional blocks that pertain to characteristic parts of the present embodiment, the radio base station 10 has other functional blocks that are necessary for radio communication as well. As illustrated in FIG. 15, the baseband signal processing section 104 has a control section 301, a transmission signal generation section 302, a mapping section 303, a received signal processing section 304 and a measurement section 305.

The control section 301 controls the whole of the radio base station 10. The control section 301 controls, for example, the scheduling of DL signals and UL signals, the DL signal generation processes in the transmission signal generation section 302 (for example, encoding, modulation, mapping, etc.), the mapping of DL signals in the mapping section 303, the UL signal receiving processes in the received signal processing section 304 (for example, demapping, demodulation, decoding, etc.) and the measurements in the measurement section 305.

To be more specific, the control section 301 controls the precoding of a DL signal (for example, PDSCH) per on a per PRG basis. The control section 301 may exert control so that the PRG size of the DL signal is a predetermined fixed value corresponding to the system band, and the PRG size of the DL signal is reported to the user terminal 20 via higher layer signaling (for example, RRC signaling) and/or DCI.

Furthermore, the control section 301 may control the PRG size of a UL signal (for example, PUSCH) (third aspect). The control section 301 may exert control so that PRG size information, which represents the PRG size of the UL signal, is reported to the user terminals 20.

Furthermore, the control section 301 may determine the precoding matrix (PM) for the UL signal on a per PRG basis (second PM determination). The control section 301 may exert control so that PMI information to represent each PRG's precoding matrix is transmitted to the user terminals 20. This PMI information may be comprised of the PMIs of individual PRGs, or may be comprised of the PMI of a reference PRG and information to represent gaps from this PMI.

Furthermore, the control section 301 may exert control so that whether or not to precode the UL signal should be precoded on a per PRG basis is determined, and command information to indicate the determined result (that is, whether to turn on or turn off the function for precoding per PRG) is transmitted to the user terminals 20 (first autonomous control according to the fourth aspect).

Also, the control section 301 may control the measurement section 305 to perform channel estimation using a demodulation reference signal (DM-RS) that is precoded per PRG like the UL signal. The control section 301 may control the received signal processing section 304 to perform receiving processes for the UL signal, precoded per PRG, based on estimated values obtained in the measurement section 305.

The control section 301 can be constituted by a controller, a control circuit or control apparatus that can be described based on general understanding of the technical field to which the present invention pertains.

The transmission signal generation section 302 may generate at least one of a DL signal (which may be a DL data signal, a DL control signal, a DL reference signal and/or the like), information sent by higher layer signaling, and DCI, based on a command from the control section 301, and output this signal to the mapping section 303.

To be more specific, the transmission signal generation section 302 precodes a DL signal (for example, PDSCH) on a per PRG basis, based on a command from the control section 301. Also, in the transmission signal generation section 302, a demodulation reference signal (DM-RS) may be precoded by using the same precoding matrix as that of as the DL signal, per PRG, and multiplexed over the DL signal. For the transmission signal generation section 302, a signal generator, a signal generation circuit or signal generation apparatus that can be described based on general understanding of the technical field to which the present invention pertains can be used.

The mapping section 303 maps the signals generated in the transmission signal generation section 302 to predetermined radio resources based on commands from the control section 301, and outputs these to the transmitting/receiving sections 103. For the mapping section 303, a mapper, a mapping circuit or mapping apparatus that can be described based on general understanding of the technical field to which the present invention pertains can be used.

The received signal processing section 304 performs receiving processes (for example, demapping, demodulation, decoding, etc.) for a UL signal transmitted from the user terminals 20 (which may be, for example, a UL data signal, a UL control signal, a UL reference signal and/or the like). To be more specific, the received signal processing section 304 may output the received signal, the signal after receiving processes and so on, to the measurement section 305. To be more specific, the received signal processing section 304 performs UL signal receiving processes based on the result of channel estimation using the DM-RS in the measurement section 305.

The measurement section 305 conducts measurements with respect to the received signal. The measurement section 305 can be constituted by a measurer, a measurement circuit or measurement apparatus that can be described based on general understanding of the technical field to which the present invention pertains.

The measurement section 305 measures UL channel states based on UL reference signals (for example, SRSs) from the user terminal 20, and outputs the measurement results to the control section 301. The measurement section 305 may also perform channel estimation for demodulating the UL signal, based on the DM-RS from the user terminal 20.

(User Terminal)

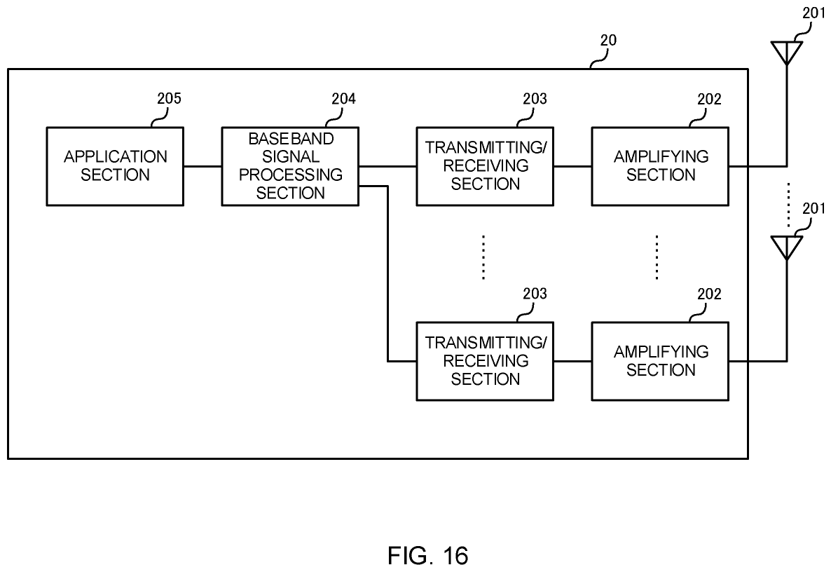

FIG. 16 is a diagram to illustrate an example of an overall structure of a user terminal according to the present embodiment. A user terminal 20 has a plurality of transmitting/receiving antennas 201 for MIMO communication, amplifying sections 202, transmitting/receiving sections 203, a baseband signal processing section 204 and an application section 205.

Radio frequency signals that are received in a plurality of transmitting/receiving antennas 201 are each amplified in the amplifying sections 202. Each transmitting/receiving section 203 receives the DL signals amplified in the amplifying sections 202. The received signals are subjected to frequency conversion and converted into the baseband signal in the transmitting/receiving sections 203, and output to the baseband signal processing section 204.

In the baseband signal processing section 204, the baseband signal that is input is subjected to an FFT process, error correction decoding, a retransmission control receiving process, and so on. The DL data is forwarded to the application section 205. The application section 205 performs processes related to higher layers above the physical layer and the MAC layer, and so on.

Meanwhile, the UL data is input from the application section 205 to the baseband signal processing section 204. The baseband signal processing section 204 performs a retransmission control process (for example, an HARQ transmission process), channel coding, rate matching, puncturing, a discrete Fourier transform (DFT) process, an IFFT process and so on, and the result is forwarded to each transmitting/receiving section 203. UCI is also subjected to at channel coding, rate matching, puncturing, a DFT process and an IFFT process, and the result is forwarded to each transmitting/receiving section 203.

Baseband signals that are output from the baseband signal processing section 204 are converted into a radio frequency band in the transmitting/receiving sections 203 and transmitted. The radio frequency signals that are subjected to frequency conversion in the transmitting/receiving sections 203 are amplified in the amplifying sections 202, and transmitted from the transmitting/receiving antennas 201.

Furthermore, the transmitting/receiving sections 203 transmit a UL signal, which is precoded on a per PRG basis. The transmitting/receiving sections 203 receive a DL signal, which is precoded on a per PRG basis.

For the transmitting/receiving sections 203, transmitters/receivers, transmitting/receiving circuits or transmitting/receiving apparatus that can be described based on general understanding of the technical field to which the present invention pertains can be used. Furthermore, a transmitting/receiving section 203 may be structured as one transmitting/receiving section, or may be formed with a transmitting section and a receiving section.

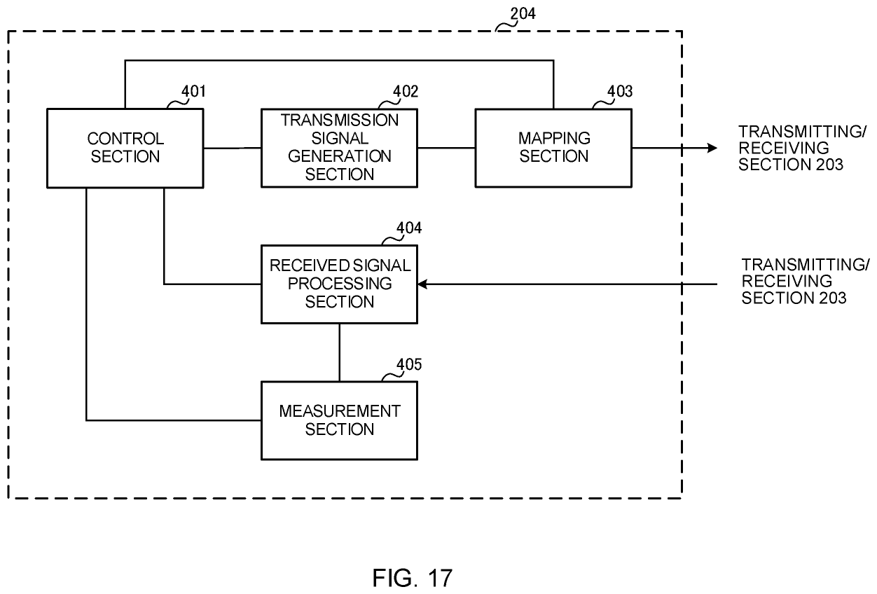

FIG. 17 is a diagram to illustrate an example of a functional structure of a user terminal according to the present embodiment. Note that, although FIG. 17 primarily illustrates functional blocks that pertain to characteristic parts of the present embodiment, the user terminal 20 has other functional blocks that are necessary for radio communication as well. As illustrated in FIG. 17, the baseband signal processing section 204 provided in the user terminal 20 has a control section 401, a transmission signal generation section 402, a mapping section 403, a received signal processing section 404 and a measurement section 405.

The control section 401 controls the whole of the user terminal 20. The control section 401 controls, for example, DL signal receiving processes by the received signal processing section 404, UL signal generation processes by the transmission signal generation section 402, mapping of UL signals by the mapping section 403, and measurement by the measurement section 405.

To be more specific, the control section 401 controls the receiving processes (for example, demapping, demodulation, decoding, etc.) of the DL signal (for example, PDSCH) based on DCI (DL assignment). Also, the control section 401 controls the generation and transmission processes (for example, encoding, modulation, mapping etc.) of the UL signal (for example, PUSCH) based on DCI (UL grant).

Furthermore, the control section 401 controls the precoding of the UL signal (for example, PUSCH) on a per PRG basis. Furthermore, the control section 401 controls the size of PRGs in the frequency direction. Furthermore, the control section 401 may control the size of PRGs in the time direction as well. In the following description, the size of PRGs in the frequency direction and/or the time direction will be referred to as “PRG size.”

For example, the control section 401 may set the PRG size of the UL signal to a predetermined fixed value corresponding to the system band (first aspect). Furthermore, the control section 401 may determine the PRG size of the UL signal based on the PRG size of the DL signal (second aspect). Furthermore, the control section 401 may determine the PRG size of the UL signal to be the size specified by the radio base station 10 (third aspect).

Furthermore, the control section 401 may determine the PRG size of the UL signal autonomously (fourth aspect). The control section 401 may determine the PRG size of the UL signal autonomously based on a command from the radio base station 10 (first autonomous control), or determine the PRG size of the UL signal autonomously without a command from the radio base station 10 (second autonomous control). Also, the control section 401 may exert control so that precoding information, which indicates this PRG size and/or which indicates that the UL signal is precoded on a per PRG basis, is transmitted to the radio base station 10.

Furthermore, the control section 401 may determine the precoding matrix (PM) for the UL signal on a per PRG basis (first PM determination). The control section 401 may exert control so that PMI information, which represents the precoding matrices of individual PRGs, is transmitted to the radio base station 10.

Alternatively, the control section 401 may exert control so that a demodulation reference signal (DM-RS), which is precoded on a per PRG basis using the same PM as that of the UL signal, is multiplexed over this UL signal and transmitted.

In addition, the control section 401 may control the measurement section 405 to perform channel estimation for demodulating the DL signal using the DM-RS multiplexed with the DL signal. The control section 401 may control the received signal processing section 304 to perform the receiving processes of the DL signal, which is precoded on a per PRG basis, based on estimated values obtained in the measurement section 405.

For the control section 401, a controller, a control circuit or control apparatus that can be described based on general understanding of the technical field to which the present invention pertains can be used.

In the transmission signal generation section 402, a UL signal (which may be a UL data signal, a UL control signal, a UL reference signal and/or the like) is generated (including, for example, encoding, rate matching, puncturing, modulation, etc.) based on a command from the control section 401, and output to the mapping section 403. For the transmission signal generation section 402, a signal generator, a signal generation circuit or signal generation apparatus that can be described based on general understanding of the technical field to which the present invention pertains can be used.

To be more specific, the transmission signal generation section 402 precodes a UL signal (for example, PUSCH) on a per PRG basis, based on a command from the control section 401. Furthermore, in the transmission signal generation section 402, a demodulation reference signal (DM-RS) is precoded using the same precoding matrix as that of the UL signal, per PRG, and multiplexed with this UL signal.

The mapping section 403 maps the UL signals generated in the transmission signal generation section 402 to radio resources based on commands from the control section 401, and output the result to the transmitting/receiving sections 203. For the mapping section 403, a mapper, a mapping circuit or mapping apparatus that can be described based on general understanding of the technical field to which the present invention pertains can be used.

The received signal processing section 404 performs receiving processes (for example, demapping, demodulation, decoding, etc.) for the DL signal (including DL data signal, DL control signal and DL reference signal). To be more specific, received signal processing section 404 performs DL signal receiving processes based on the result of channel estimation using the DM-RS in the measurement section 405.

The received signal processing section 404 outputs the information received from the radio base station 10, to the control section 401. The received signal processing section 404 outputs, for example, broadcast information, system information, higher layer control information by higher layer signaling such as RRC signaling, L1/L2 control information (for example, UL grant, DL assignment, etc.) and so on to the control section 401.

The received signal processing section 404 can be constituted by a signal processor, a signal processing circuit or signal processing apparatus that can be described based on general understanding of the technical field to which the present invention pertains. Also, the received signal processing section 404 can constitute the receiving section according to the present invention.

The measurement section 405 measures channel states based on a reference signal (for example, CSI-RS) from the radio base station 10, and outputs the measurement results to the control section 401. The measurement section 405 may also perform channel estimation for demodulate the DL signal, using the DM-RS from radio base station 10.

The measurement section 405 can be constituted by a signal processor, a signal processing circuit or signal processing apparatus, and a measurer, a measurement circuit or measurement apparatus that can be described based on general understanding of the technical field to which the present invention pertains.

(Hardware Structure)

Note that the block diagrams that have been used to describe the above embodiments illustrate blocks in functional units. These functional blocks (components) may be implemented in arbitrary combinations of hardware and/or software. Also, the means for implementing each functional block is not particularly limited. That is, each functional block may be realized by one piece of apparatus that is physically and/or logically aggregated, or may be realized by directly and/or indirectly connecting two or more physically and/or logically separate pieces of apparatus (via wire or wireless, for example) and using these multiple pieces of apparatus.

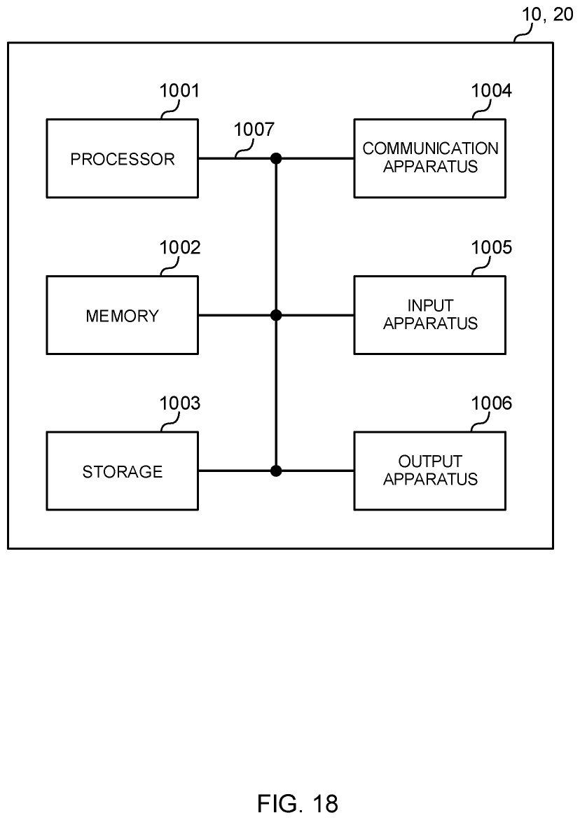

For example, the radio base station, user terminals and so on according to embodiments of the present invention may function as a computer that executes the processes of the radio communication method of the present invention. FIG. 18 is a diagram to illustrate an example hardware structure of a radio base station and a user terminal according to one embodiment of the present invention. Physically, the above-described radio base stations 10 and user terminals 20 may be formed as computer apparatus that includes a processor 1001, a memory 1002, a storage 1003, communication apparatus 1004, input apparatus 1005, output apparatus 1006 and a bus 1007.

Note that, in the following description, the word “apparatus” may be replaced by “circuit,” “device,” “unit” and so on. Note that the hardware structure of a radio base station 10 and a user terminal 20 may be designed to include one or more of each apparatus illustrated in the drawing, or may be designed not to include part of the apparatus.

For example, although only one processor 1001 is illustrated, a plurality of processors may be provided. Furthermore, processes may be implemented with one processor, or processes may be implemented in sequence, or in different manners, on two or more processors. Note that the processor 1001 may be implemented with one or more chips.

Each function of the radio base station 10 and the user terminal 20 is implemented by allowing predetermined software (programs) to be read on hardware such as the processor 1001 and the memory 1002, and by allowing the processor 1001 to do calculations, the communication apparatus 1004 to communicate, and the memory 1002 and the storage 1003 to read and/or write data.

The processor 1001 may control the whole computer by, for example, running an operating system. The processor 1001 may be configured with a central processing unit (CPU), which includes interfaces with peripheral apparatus, control apparatus, computing apparatus, a register and so on. For example, the above-described baseband signal processing section 104 (204), call processing section 105 and others may be implemented by the processor 1001.

Furthermore, the processor 1001 reads programs (program codes), software modules or data, from the storage 1003 and/or the communication apparatus 1004, into the memory 1002, and executes various processes according to these. As for the programs, programs to allow computers to execute at least part of the operations of the above-described embodiments may be used. For example, the control section 401 of the user terminals 20 may be implemented by control programs that are stored in the memory 1002 and that operate on the processor 1001, and other functional blocks may be implemented likewise.

The memory 1002 is a computer-readable recording medium, and may be constituted by, for example, at least one of a ROM (Read Only Memory), an EPROM (Erasable Programmable ROM), an EEPROM (Electrically EPROM), a RAM (Random Access Memory) and/or other appropriate storage media. The memory 1002 may be referred to as a “register,” a “cache,” a “main memory (primary storage apparatus)” and so on. The memory 1002 can store executable programs (program codes), software modules and/and so on for implementing the radio communication methods according to embodiments of the present invention.

The storage 1003 is a computer-readable recording medium, and may be constituted by, for example, at least one of a flexible disk, a floppy (registered trademark) disk, a magneto-optical disk (for example, a compact disc (CD-ROM (Compact Disk ROM) and so on), a digital versatile disc, a Blu-ray (registered trademark) disk), a removable disk, a hard disk drive, a smart card, a flash memory device (for example, a card, a stick, a key drive, etc.), a magnetic stripe, a database, a server, and/or other appropriate storage media. The storage 1003 may be referred to as “secondary storage apparatus.”

The communication apparatus 1004 is hardware (transmitting/receiving device) for allowing inter-computer communication by using wired and/or wireless networks, and may be referred to as, for example, a “network device,” a “network controller,” a “network card,” a “communication module” and so on. The communication apparatus 1004 may be comprised of a high frequency switch, a duplexer, a filter, a frequency synthesizer and so on in order to realize, for example, frequency division duplex (FDD) and/or time division duplex (TDD). For example, the above-described transmitting/receiving antennas 101 (201), amplifying sections 102 (202), transmitting/receiving sections 103 (203), communication path interface 106 and so on may be implemented by the communication apparatus 1004.

The input apparatus 1005 is an input device for receiving input from the outside (for example, a keyboard, a mouse, a microphone, a switch, a button, a sensor and so on). The output apparatus 1006 is an output device for allowing sending output to the outside (for example, a display, a speaker, an LED (Light Emitting Diode) lamp and so on). Note that the input apparatus 1005 and the output apparatus 1006 may be provided in an integrated structure (for example, a touch panel).

Furthermore, these types of apparatus, including the processor 1001, the memory 1002 and others, are connected by a bus 1007 for communicating information. The bus 1007 may be formed with a single bus, or may be formed with buses that vary between pieces of apparatus.

Also, the radio base station 10 and the user terminal 20 may be structured to include hardware such as a microprocessor, a digital signal processor (DSP), an ASIC (Application-Specific Integrated Circuit), a PLD (Programmable Logic Device), an FPGA (Field Programmable Gate Array) and so on, and part or all of the functional blocks may be implemented by the hardware. For example, the processor 1001 may be implemented with at least one of these pieces of hardware.

(Variations)

Note that the terminology used in this specification and the terminology that is needed to understand this specification may be replaced by other terms that convey the same or similar meanings. For example, “channels” and/or “symbols” may be replaced by “signals (or “signaling”).” Also, “signals” may be “messages.” A reference signal may be abbreviated as an “RS,” and may be referred to as a “pilot,” a “pilot signal” and so on, depending on which standard applies. Furthermore, a “component carrier (CC)” may be referred to as a “cell,” a “frequency carrier,” a “carrier frequency” and so on.

Furthermore, a radio frame may be comprised of one or more periods (frames) in the time domain. Each of one or more periods (frames) constituting a radio frame may be referred to as a “subframe.” Furthermore, a subframe may be comprised of one or more slots in the time domain. Furthermore, a slot may be comprised of one or more symbols in the time domain (OFDM (Orthogonal Frequency Division Multiplexing) symbols, SC-FDMA (Single Carrier Frequency Division Multiple Access) symbols, and so on).

A radio frame, a subframe, a slot and a symbol all represent the time unit in signal communication. A radio frame, a subframe, a slot and a symbol may be each called by other applicable names. For example, one subframe may be referred to as a “transmission time interval (TTI),” a plurality of consecutive subframes may be referred to as a “TTI,” or one slot may be referred to as a “TTI.” That is, a subframe and a TTI may be a subframe (1 ms) in existing LTE, may be a shorter period than 1 ms (for example, one to thirteen symbols), or may be a longer period of time than 1 ms.

Here, a TTI refers to the minimum time unit of scheduling in radio communication, for example. For example, in LTE systems, a radio base station schedules the allocation of radio resources (such as the frequency bandwidth and transmission power that can be used by each user terminal) for each user terminal in TTI units. Note that the definition of TTIs is not limited to this. The TTI may be the transmission time unit of channel-encoded data packets (transport blocks), or may be the unit of processing in scheduling, link adaptation and so on.

A TTI having a time duration of 1 ms may be referred to as a “normal TTI (TTI in LTE Rel. 8 to 12),” a “long TTI,” a “normal subframe,” a “long subframe,” and so on. A TTI that is shorter than a normal TTI may be referred to as a “shortened TTI,” a “short TTI,” a “shortened subframe,” a “short subframe,” and so on.

A resource block (RB) is the unit of resource allocation in the time domain and the frequency domain, and may include one or a plurality of consecutive subcarriers in the frequency domain. Also, an RB may include one or more symbols in the time domain, and may be one slot, one subframe or one TTI in length. One TTI and one subframe each may be comprised of one or more resource blocks. Note that an RB may be referred to as a “physical resource block (PRB (Physical RB)),” a “PRB pair,” an “RB pair,” and so on.

Furthermore, a resource block may be comprised of one or more resource elements (REs). For example, one RE may be a radio resource field of one subcarrier and one symbol.

Note that the above-described structures of radio frames, subframes, slots, symbols and so on are merely examples. For example, configurations such as the number of subframes included in a radio frame, the number of slots included in a subframe, the number of symbols and RBs included in a slot, the number of subcarriers included in an RB, the number of symbols in a TTI, the symbol duration and the cyclic prefix (CP) duration can be variously changed.

Also, the information and parameters described in this specification may be represented in absolute values or in relative values with respect to predetermined values, or may be represented in other information formats. For example, radio resources may be specified by predetermined indices. In addition, equations to use these parameters and so on may be used, apart from those explicitly disclosed in this specification.

The names used for parameters and so on in this specification are in no respect limiting. For example, since various channels (PUCCH (Physical Uplink Control CHannel), PDCCH (Physical Downlink Control CHannel) and so on) and information elements can be identified by any suitable names, the various names assigned to these individual channels and information elements are in no respect limiting.

The information, signals and/or others described in this specification may be represented by using a variety of different technologies. For example, data, instructions, commands, information, signals, bits, symbols and chips, all of which may be referenced throughout the herein-contained description, may be represented by voltages, currents, electromagnetic waves, magnetic fields or particles, optical fields or photons, or any combination of these.

Also, information, signals and so on can be output from higher layers to lower layers and/or from lower layers to higher layers. Information, signals and so on may be input and output via a plurality of network nodes.

The information, signals and so on that are input and/or output may be stored in a specific location (for example, a memory), or may be managed using a management table. The information, signals and so on to be input and/or output can be overwritten, updated or appended. The information, signals and so on that are output may be deleted. The information, signals and so on that are input may be transmitted to other pieces of apparatus.

Reporting of information is by no means limited to the aspects/embodiments described in this specification, and other methods may be used as well. For example, reporting of information may be implemented by using physical layer signaling (for example, downlink control information (DCI), uplink control information (UCI), higher layer signaling (for example, RRC (Radio Resource Control) signaling, broadcast information (the master information block (MIB), system information blocks (SIBs) and so on), MAC (Medium Access Control) signaling and so on), and other signals and/or combinations of these.

Note that physical layer signaling may be referred to as “L1/L2 (Layer 1/Layer 2) control information (L1/L2 control signals),” and so on. Also, RRC signaling may be referred to as “RRC messages,” and can be, for example, an RRC connection setup message, RRC connection reconfiguration message, and so on. Also, MAC signaling may be reported using, for example, MAC control elements (MAC CEs (Control Elements)).

Also, reporting of predetermined information (for example, reporting of information to the effect that “X holds”) does not necessarily have to be sent explicitly, and can be sent implicitly (by, for example, not reporting this piece of information or by reporting another piece of information).

Decisions may be made in values represented by one bit (0 or 1), may be made in Boolean values that represent true or false, or may be made by comparing numerical values (for example, comparison against a predetermined value).

Software, whether it is referred to as “software,” “firmware,” “middleware,” “microcode” or “hardware description language,” or called by other names, should be interpreted broadly, to mean instructions, instruction sets, code, code segments, program codes, programs, subprograms, software modules, applications, software applications, software packages, routines, subroutines, objects, executable files, execution threads, procedures, functions and so on.

Also, software, commands, information and so on may be transmitted and received via communication media. For example, when software is transmitted from a website, a server or other remote sources by using wired technologies (coaxial cables, optical fiber cables, twisted-pair cables, digital subscriber lines (DSL) and so on) and/or wireless technologies (infrared radiation, microwaves and so on), these wired technologies and/or wireless technologies are also included in the definition of communication media.

The terms “system” and “network” as used herein are used interchangeably.

As used herein, the terms “base station (BS),” “radio base station,” “eNB,” “cell,” “sector,” “cell group,” “carrier,” and “component carrier” may be used interchangeably. A base station may be referred to as a “fixed station,” “NodeB,” “eNodeB (eNB),” “access point,” “transmission point,” “receiving point,” “femto cell,” “small cell” and so on.

A base station can accommodate one or more (for example, three) cells (also referred to as “sectors”). When a base station accommodates a plurality of cells, the entire coverage area of the base station can be partitioned into multiple smaller areas, and each smaller area can provide communication services through base station subsystems (for example, indoor small base stations (RRHs (Remote Radio Heads))). The term “cell” or “sector” refers to part or all of the coverage area of a base station and/or a base station subsystem that provides communication services within this coverage.

As used herein, the terms “mobile station (MS)” “user terminal,” “user equipment (UE)” and “terminal” may be used interchangeably. A base station may be referred to as a “fixed station,” “NodeB,” “eNodeB (eNB),” “access point,” “transmission point,” “receiving point,” “femto cell,” “small cell” and so on.

A mobile station may be referred to, by a person skilled in the art, as a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client” or some other suitable terms.

Furthermore, the radio base stations in this specification may be interpreted as user terminals. For example, each aspect/embodiment of the present invention may be applied to a configuration in which communication between a radio base station and a user terminal is replaced with communication among a plurality of user terminals (D2D (Device-to-Device)). In this case, user terminals 20 may have the functions of the radio base stations 10 described above. In addition, wording such as “uplink” and “downlink” may be interpreted as “side.” For example, an uplink channel may be interpreted as a side channel.

Likewise, the user terminals in this specification may be interpreted as radio base stations. In this case, the radio base stations 10 may have the functions of the user terminals 20 described above.

Certain actions which have been described in this specification to be performed by base stations may, in some cases, be performed by upper nodes. In a network comprised of one or more network nodes with base stations, it is clear that various operations that are performed to communicate with terminals can be performed by base stations, one or more network nodes (for example, MMEs (Mobility Management Entities), S-GW (Serving-Gateways), and so on may be possible, but these are not limiting) other than base stations, or combinations of these.

The aspects/embodiments illustrated in this specification may be used individually or in combinations, which may be switched depending on the mode of implementation. The order of processes, sequences, flowcharts and so on that have been used to describe the aspects/embodiments herein may be re-ordered as long as inconsistencies do not arise. For example, although various methods have been illustrated in this specification with various components of steps in exemplary orders, the specific orders that are illustrated herein are by no means limiting.

The aspects/embodiments illustrated in this specification may be applied to systems that use LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), NR(New Radio), NX (New radio access), FX (Future generation radio access), GSM (registered trademark) (Global System for Mobile communications), CDMA 2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), systems that use other adequate radio communication methods, and/or next-generation systems that are enhanced based on these.

The phrase “based on” as used in this specification does not mean “based only on,” unless otherwise specified. In other words, the phrase “based on” means both “based only on” and “based at least on.”

Reference to elements with designations such as “first,” “second” and so on as used herein does not generally limit the number/quantity or order of these elements. These designations are used herein only for convenience, as a method of distinguishing between two or more elements. In this way, reference to the first and second elements does not imply that only two elements may be employed, or that the first element must precede the second element in some way.

The terms “judge” and “determine” as used herein may encompass a wide variety of actions. For example, to “judge” and “determine” as used herein may be interpreted to mean making judgements and determinations related to calculating, computing, processing, deriving, investigating, looking up (for example, searching a table, a database or some other data structure), ascertaining and so on.

Furthermore, to “judge” and “determine” as used herein may be interpreted to mean making judgements and determinations related to receiving (for example, receiving information), transmitting (for example, transmitting information), inputting, outputting, accessing (for example, accessing data in a memory) and so on. In addition, to “judge” and “determine” as used herein may be interpreted to mean making judgements and determinations related to resolving, selecting, choosing, establishing, comparing and so on. In other words, to “judge” and “determine” as used herein may be interpreted to mean making judgements and determinations related to some action.

As used herein, the terms “connected” and “coupled,” or any variation of these terms, mean all direct or indirect connections or coupling between two or more elements, and may include the presence of one or more intermediate elements between two elements that are “connected” or “coupled” to each other. The coupling or connection between the elements may be physical, logical or a combination of these. For example, “connection” may be interpreted as “access. As used herein, two elements may be considered “connected” or “coupled” to each other by using one or more electrical wires, cables and/or printed electrical connections, and, in a number of non-limiting and non-inclusive examples, by using electromagnetic energy such as electromagnetic energy having wavelengths in the radio frequency, microwave and optical regions (both visible and invisible).

When terms such as “include,” “comprise” and variations of these are used in this specification or in claims, these terms are intended to be inclusive, in a manner similar to the way the term “provide” is used. Furthermore, the term “or” as used in this specification or in claims is intended to be not an exclusive disjunction.

Now, although the present invention has been described in detail above, it should be obvious to a person skilled in the art that the present invention is by no means limited to the embodiments described herein. The present invention can be implemented with various corrections and in various modifications, without departing from the spirit and scope of the present invention defined by the recitations of claims. Consequently, the description herein is provided only for the purpose of explaining examples, and should by no means be construed to limit the present invention in any way.

1. A terminal comprising:
a transmitter that transmits an uplink (UL) signal which is precoded per precoding group that includes a given number of frequency resource units; and
a processor that controls precoding of the UL signal,
wherein the processor determines a size of the precoding group of the UL signal based on a downlink signal (DL) signal.

2. The terminal according to claim 1, wherein:
the precoding group includes a given number of time resource units; and
the processor controls a size of the precoding group in a time direction.

3. The terminal according to claim 1, wherein the processor sets the size of the precoding group to a fixed size based on a system bandwidth of the terminal.

4. The terminal according to claim 1, wherein the processor determines the size of the precoding group based on a size of a precoding group of the DL.

5. The terminal according to claim 1, wherein the processor determines the size of the precoding group to be a size specified by a radio base station, or the processor determines the size of the precoding group autonomously based on a command from the radio base station or without the command from the radio base station.

6. A radio communication method comprising:
in a terminal, precoding a uplink (UL) signal per precoding group that includes a given number of frequency resource units;
in the terminal, transmitting the uplink (UL) signal; and
in the terminal, determining a size of the precoding group based on a downlink signal (DL) signal.

7. The terminal according to claim 2, wherein the processor sets the size of the precoding group to a fixed size based on a system bandwidth of the terminal.

8. The terminal according to claim 2, wherein the processor determines the size of the precoding group based on a size of a precoding group of the DL.

9. The terminal according to claim 2, wherein the processor determines the size of the precoding group to be a size specified by a radio base station, or the processor determines the size of the precoding group autonomously based on a command from the radio base station or without the command from the radio base station.
